(19) United States
(12) Patent Application Publication
(10) Pub. No.: US 2005/0272826 A1
(43) Pub. Date: Dec. 8, 2005

(54) Dispersion of sintered materials

(76) Inventors: Helmut Mangold, Rodenbach (DE); Jurgen Meyer, Stockstadt/Main (DE); Gerrit Schneider, Hanau (DE)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/129,845

(22) Filed: May 16, 2005

Related U.S. Application Data
(62) Division of application No. 09/632,208, filed on Aug. 3, 2000, now abandoned.
(60) Provisional application No. 60/147,088, filed on Aug. 4, 1999.

(30) Foreign Application Priority Data
Aug. 3, 1999 (DE) 1199 36 478.8

(51) Int. Cl. C01B 33/14; C03C 3/06

(52) U.S. Cl. 516/34; 501/54; 423/335; 501/133

(57) ABSTRACT

Sintered materials, especially sintered glasses, produced from pyrogenically produced silicon dioxide which has been processed to silicon granulates in a compacting step, and the use of such granulates in the production of formed glass bodies.

### CROSS-REFERENCE TO RELATED APPLICATIONS

This application is based on German Application DE 1199 36 478.8, filed Aug. 3, 1999, and U.S. provisional application Ser. No. 60/147,088, filed Aug. 4, 1999, which disclosures are incorporated herein by reference.

### FIELD OF THE INVENTION

The invention relates to sintered materials, especially sintered glasses, to a process for the production of sintered materials from pyrogenically produced silicon dioxide which has been processed to silicon dioxide granulates by means of a downstream compacting step, and to the use of corresponding silicon dioxide granulates in the production of sintered materials.

### BACKGROUND OF THE INVENTION

It is known to convert silicon alkoxide solutions by the action of an acid into gel bodies, which are dried and then subjected to a sintering step (DE 30 01 792 C2 which corresponds to U.S. Pat. No. 4,323,381). Such processes are generally called “sol-gel processes”. Glasses produced in this manner can be used according to the invention in the production of preformed bodies for subsequent further processing to optical fibers.

It is also known to use nano-scale powders, such as, for example, pyrogenically produced silicon dioxide, in the production of sintered glass bodies (U.S. Pat. No. 5,379,364). In that process, a starting silica having a surface area of less than 100 m²/g is used and a dispersion having a solids content of more than 30 wt. % is prepared. After being transferred to a form, the dispersion is gelled by lowering the pH value. The gel body is then dried to form a green body, which is subjected to a cleaning step and is then sintered. In contrast to the process outlined in U.S. Pat. No. 4,323,381, processes such as that of U.S. Pat. No. 5,379,364 are so-called “colloidal sol-gel processes”.

Known processes in which formed glass bodies are produced according to the “sol-gel process” using only silicon alkoxide solutions have the disadvantage that the gel body shrinks considerably during the drying process and during the sintering process. The shrinkage can be from 60% to over 80% of the original dimensions of the gel body. As a result of this considerable drying and sintering shrinkage very fine seeds, flaws and cracks develop within the glass body that is produced, which have an adverse effect on the properties of the product. For example, the optical transmission of such formed glass bodies is reduced considerably by such seeds, flaws and cracks and the optical homogeneity is impaired. Because of the correspondingly high optical attenuation, such formed glass bodies cannot be used for the production of high-quality optical fibers. The known sol-gel processes also have the disadvantage that the gel body has extremely fine capillaries and pores. The liquid contained in the gel body exerts a high hydrodynamic pressure on the capillaries during the drying process, which in the process of drying the gel body likewise leads to the appearance of ultrafine cracks, flaws or seeds.

As compared with the “sol-gel processes”, known “colloidal sol-gel processes” have the advantage that the drying and sintering shrinkage is reduced a little. The reason for the reduced shrinkage is the use of pyrogenically produced silicon dioxide, which permits higher degrees of filling of the oxide in dispersions used for the production of sintered glasses. Nevertheless, the colloidal sol-gel processes known hitherto exhibit considerable drying and sintering shrinkage. The shrinkage in these processes can still be from 35% to 50% of the dimensions of the gel body before drying. However, in order to further improve the optical properties of sintered glasses produced in this manner, a further increase in the degrees of filling of the silicon dioxide powder within the powder-technological production process is required. However, the necessary high degrees of filling cannot be achieved using known pyrogenically produced silicon dioxide powders having a low degree of compaction. The result is that the optical transparency of the preformed body produced therefrom for the production of optical fibers is poorer than that desired for the final product.

As compared with simple sol-gel processes, the known colloidal sol-gel processes cause a slightly improved capillary and pore structure of the gel body. For that reason, when gel bodies produced by means of colloidal sol-gel processes are dried, fewer internal ultrafine cracks, flaws or seeds are formed than is the case when gel bodies produced by means of a simple “sol-gel process” are dried. Nevertheless, it is desirable to improve the capillary and pore structure further.

### SUMMARY OF THE INVENTION

Accordingly, the object of the invention is to develop sintered materials with improved capillary and pore structure.

The invention provides sintered materials, especially sintered glasses, which are produced by means of a forming or compacting process, optionally a subsequent cleaning step and optionally a subsequent sintering process. For the production of the sintered materials, either pyrogenically produced silicon dioxide which has been compacted to granulates by means of a downstream compacting step according to DE 196 01 415 A1 is used, which corresponds to U.S. Pat. No. 5,776,240, having a tamped density of from 150 g/l to 800 g/l, preferably from 200 to 500 g/l, a granulate particle size of from 10 to 800 μm and a BET surface area of from 10 to 500 m²/g, preferably from 20 to 130 m²/g, or granulates according to U.S. Pat. No. 5,776,240, based on pyrogenically produced silicon dioxide are used, having the following physico-chemical data: mean particle diameter from 25 to 120 μm; BET surface area from 40 to 400 m²/g; pore volume from 0.5 to 2.5 ml/g; pore distribution: no pores with a diameter<5 nm, only meso- and macro-pores are present; pH value from 3.6 to 8.5; tamped density from 220 to 700 g/l.

Examples of such production processes are the production of an aqueous granulate dispersion, transfer of the dispersion into a form, and gelling of the dispersion to form a gel body. The latter can be processed to high-quality formed glass bodies by means of a drying process and a sintering process. A further example of such processes is the dry pressing of highly compacted pyrogenically produced silicon dioxide granulate to a solid formed body, and subsequent sintering of the formed body to sintered glass.

The invention provides the above-mentioned sintered materials, wherein the described granulates are processed to the sintered material by means of a process of a following type:

a) preparation of a dispersion of granulates having a solids content of from 10 wt. % to 85 wt. %, preferably from 25 wt. % to 70 wt. %, and a polar or non-polar inorganic or organic liquid, preferably water, ethanol or aliphatic, hydrocarbons; followed by either transfer of the dispersion into a form or, alternatively, coating of surfaces with the dispersion, and then initiation of gelling of the dispersion and drying of the gel body or of the gel-body-like coating to obtain a green body or green body-like coating. The green body obtained after the drying operation, or the green-body-like coating, can optionally be cleaned with gaseous substances, such as chlorine or thionyl chloride, at temperatures of from 700° to 1000° C. and then can optionally be sintered by means of a sintering step at a temperature of from 1000° to 1800° C., preferably from 1100° to 1600° C., in such a manner that the resulting sintered body or the sintered surface is fully dense-sintered or is still partially porous; or

b) introduction of corresponding granulates, without the aid of a liquid, into a form or, alternatively, application of the granulates to a surface, followed optionally by a further compacting step in which the formed body or the surface layer is pressed under a high external mechanical pressure (pressing pressure for Example 1 is 120 MPa) in the presence of atmospheric pressure or at reduced pressure, and is compacted further. The formed body obtained after the pressing operation, or the compacted coating, can optionally be cleaned with gaseous substances, such as chlorine or thionyl chloride, at temperatures of from 700° to 1000° C. and sintered by means of a sintering step at a temperature of from 1000° to 1800° C., preferably from 1100° to 1600° C., in such a manner that the resulting sintered body or the sintered surface is fully dense-sintered or is still partially porous; or

c) application of corresponding granulates to formed bodies and surfaces by thermal or other high-energy processes, such as, for example, flame spraying, plasma coating or microwave sintering, in which a solid formed body or a solid coating is obtained and the resulting sintered body or the sintered surface is fully dense-sintered or is still partially porous. The invention also provides materials or glasses characterized in that, in the production of the materials or glasses, the granulates according to the invention, by means of the action of thermal, electric or electromagnetic energy, for example, by means of burners, plasma torches or microwave radiation, either are brought into any desired form before or after heating and are then sintered in such a manner that the resulting sintered body or the sintered surface is fully dense-sintered or is still partially porous, or are melted partially or completely, are brought into any desired form before or after heating and solidify in that form or are used for coating other materials, such as, for example, glass or metal, and are then optionally after-treated.

The invention provides glasses characterized in that sintering to a transparent glass body or to a transparent glass layer takes place within the viscosity range of the glass of from 10⁸ to 10¹² dpas, but preferably from 10¹⁰ to 10¹¹ dpas.

The invention provides glasses characterized in that they are at least water-resistant according to hydrolytic class 2, preferably water-resistant according to hydrolytic class 1.

The invention provides glasses in which the properties of the glasses sintered or melted from corresponding very fine powder particles correspond to the properties of a glass having an identical chemical composition that has been produced via a conventional melting process without using the mentioned granulates. The production of such sintered glasses requires markedly lower sintering temperatures as compared with the melting temperature which is necessary to produce a glass having an identical composition with a conventional melting process.

In addition, the invention provides dispersions which are used in the production of sintered materials and have the following properties:

a) solids contents of the above-mentioned granulates of from 10 wt. % to 85 wt. %, preferably from 25 wt. % to 70 wt. %, in a dispersion with a polar or non-polar inorganic or organic liquid, preferably water, ethanol or aliphatic hydrocarbons; or

b) solids contents of the granulates according to the invention of from 10 wt. % to 85 wt. %, preferably from 25 wt. % to 70 wt. %, in an aqueous dispersion which has a pH value of from 1 to 6 or a pH value of from 8 to 12 and is adjusted to the corresponding pH value using organic acids, such as, for example, formic acid, citric acid or trichloroacetic acid, using inorganic acids, such as, for example, nitric acid, phosphoric acid or sulfuric acid, using organic bases, such as, for example, triethylamine, pyridine or tetramethylammonium hydroxide, or using inorganic bases, such as, for example, potassium hydroxide, calcium hydroxide or ammonium hydroxide; or

c) solids contents of the granulates according to the invention of from 10 wt. % to 85 wt. %, preferably from 25 wt. % to 70 wt. %, in an aqueous dispersion which has a pH value of from 1 to 6 or a pH value of from 8 to 12 and is adjusted to the corresponding pH value using organic or inorganic acids or bases and which contains other additives permitting increased granulate contents and an improved dispersibility, such as, for example, polymers or ionic compounds, which contribute towards steric or ionic stabilization of the dispersion and reduce or prevent the settling of solids portions and/or prevent premature gelling; or

d) solids contents of the granulates according to the invention of from 10 wt. % to 85 wt. %, preferably from 25 wt. % to 70 wt. %, in an aqueous dispersion which has a pH value of from 1 to 6 or a pH value of from 8 to 12 and is adjusted to the corresponding pH value using organic or inorganic acids or bases and which can contain other additives permitting improved dispersing, gelling, drying and cleaning as well as sintering of the subsequent sintered material, such as, for example, metal alkoxides of the formula Me(OR)ₓ wherein Me represents a metal, preferably silicon, R represents an alkyl group, and “x” corresponds to the valency of the metal ion. There may also be added to such dispersions other organic binder materials, such as, for example, polymers or resins, which likewise permit an improved product quality of the sintered material, such as, for example, an improvement in the freedom from pores or in the optical transmission, or a simplified process which uses higher degrees of filling and has a lower drying/sintering shrinkage; or

e) solids contents of the granulates according to the invention of from 1 wt. % to 75 wt. %, preferably from 5 wt. % to 50 wt. %, in an aqueous dispersion which has a pH value of from 1 to 6 or a pH value of from 8 to 12 and is adjusted to the corresponding pH value using organic or inorganic acids or bases and which can optionally contain other additives, such as, for example, metal alkoxides of the formula Me(OR)ₓ, preferably tetraethoxysilane. There may be added to such dispersions pyrogenically produced oxides in an amount by weight of from 1 to 65 wt. %, preferably from 1 to 50 wt. %, such as, for example, silicon dioxide, titanium dioxide, aluminum oxide, zirconium dioxide or mixed oxides of the corresponding metals. The corresponding pyrogenic oxides can be added to the dispersion both in the uncompacted state and after preliminary compaction other than that described in DE 196 01 415 A1 has been carried out; or

f) solids contents of the granulates according to the invention of from 1 wt. % to 75 wt. %, preferably from 5 wt. % to 50 wt. %, in an aqueous dispersion which has a pH value of from 1 to 6 or a pH value of from 8 to 12 and is adjusted to the corresponding pH value using organic or inorganic acids or bases and which can contain other additives permitting improved dispersing, gelling, drying and cleaning as well as sintering of the subsequent sintered material, such as, for example, metal alkoxides of the formula Me(OR)ₓ, preferably tetraethoxysilane. According to the invention there may be added to such dispersions salts or oxides of a metalloid and/or metal.

The invention relates to the use of the granulates of pyrogenically produced silicon dioxide according to the invention in the production of sintered materials, especially sintered glasses, characterized in that the granulates used have the following properties:

a) after a compacting step according to U.S. Pat. No. 5,776,240, the granulates have a tamped density of from 150 g/l to 800 g/l, preferably from 200 to 500 g/l, a granulate particle size of from 10 to 800 μm and a BET surface area of from 10 to 500 m²/g, preferably from 20 to 130 m²/g, or

b) after a compacting step according to U.S. Pat. No. 5,776,240, based on pyrogenically produced silicon dioxide, the granulates have the following physico-chemical data:
mean particle diameter: from 25 to 120 μm, BET surface area: from 40 to 400 m²/g, pore volume: from 0.5 to 2.5 ml/g, pore distribution: no pores<5 nm, only meso- and macro-pores, pH value: from 3.6 to 8.5, tamped density: from 220 to 700 g/l.

The invention provides processes for the production of sintered materials, especially sintered glasses, which are characterized in that pyrogenically produced silicon dioxide is compacted and/or granulated in a known manner and converted into a dispersion, the dispersion is gelled and dried, the resulting green body is cleaned and subsequently sintered. Gelling can take place to provide various forms, such as, for example, formed gel bodies, gel fibers, gelled layers or coatings on a substrate of glass or metal. After being dried and cleaned, the formed gel bodies or gel layers can be sintered in such a manner that a solid formed body or a solid coating is obtained and the resulting sintered body or the sintered surface is fully dense-sintered or is still partially porous.

The invention provides processes for the production of sintered materials, especially sintered glasses, which are characterized in that pyrogenically produced silicon dioxide is compacted and/or granulated in a known manner, and then:

a) the granulates, without the aid of a liquid, are introduced into a form or are applied to a surface, a further compacting step is then optionally carried out, in which the formed body or the layer is pressed under a high external mechanical pressure (pressing pressure for example from 1 to 120 MPa) in the presence of atmospheric pressure or at reduced pressure, and is compacted further. The formed body obtained after the pressing operation, or the compacted coating, can optionally be cleaned with gaseous substances, such as chlorine or thionyl chloride, at temperatures of from 700° to 1000° C. and sintered by means of a sintering step at a temperature of from 1000° to 1800° C., preferably from 1100° to 1600° C., in such a manner that the resulting sintered body or the sintered surface is fully dense-sintered or is still partially porous; or

b) granulates are applied to formed bodies and surfaces by thermal or other high-energy processes, such as, for example, flame spraying, plasma coating or microwave sintering, wherein a solid formed body or a solid coating is obtained, and the resulting sintered body or the sintered surface is fully dense-sintered or is still partially porous; or

c) the granulates are brought into any desired form by means of the action of thermal, electric or electromagnetic energy, for example, by means of burners, plasma torches or microwave radiation, either before or after heating, and are then sintered in such a manner that the resulting sintered body or the sintered surface is fully dense-sintered or is still partially porous, or the granulates are melted partially or completely, are brought into any desired form before or after heating and are allowed to solidify in that form or are used to coat other materials, such as, for example, glass or metal, and are then optionally after-treated.

The invention relates to the use of sintered materials, especially sintered glasses or glasses, in the production of formed glass bodies, such as, for example, optical fiber preformed bodies (so-called “overcladding tubes” or “core rods”), optical lenses, diffraction gratings, glass crucibles (so-called “crucibles”), electrical insulators, thermal insulators, magnetic insulators, prisms, containers or apparatus for the chemical or pharmaceutical industries, ingots, formed bodies for the electronics industry, glass bars as a raw material for further processing, and formed bodies having precise requirements as regards accuracy of shape after processing.

The invention relates to the use of sintered materials, especially sintered glasses or glasses, in the coating of other materials, such as metal, plastics or glass, with layers of materials.

The invention also relates to the use of sintered materials, especially sintered glasses or glasses, in the production of fibrous materials or fibers.

The invention further relates to the use of granulates in the production of glasses, especially sintered glasses, ceramics, composite materials, in which the granulates act as a reinforcing filler, as reinforcing fillers in metals, glasses, polymers, elastomers, lacquers or liquids.

The invention additionally relates to the use of dispersions in the production of glasses, especially sintered glasses, and in the polishing of semiconductor materials or electric circuits.

### DETAILED DESCRIPTION OF THE PREFERRED EMBODIMENTS

In a preferred embodiment of the invention, a pyrogenically produced silicon dioxide which has been granulated or compacted in a known manner according to U.S. Pat. No. 5,776,240 can be used in the production of sintered materials.

The silicon dioxide so compacted or granulated can be a pyrogenically produced oxide having a BET surface area of from 10 to 500 m²/g, a tamped density of from 150 to 800 g/l and a granulate particle size of from 10 to 800 μm.

According to the invention, mixtures of compacted and uncompacted silicon dioxide can also be used.

Salts or oxides of a metalloid and/or metal may be added to the compacted pyrogenic silicon dioxide in a dispersion.

Within the dispersion, mixtures of compacted and uncompacted pyrogenically produced silicon dioxides can also be produced.

Hereinbelow, the expressions “pyrogenically produced silica”, “pyrogenically produced silicon dioxide”, “pyrogenic silica” and “pyrogenic silicon dioxide” are to be understood as meaning very finely divided, nano-scale powders produced by converting gaseous silicon tetrachloride, such as, for example, methyltrichlorosilane or silicon tetrachloride in a high-temperature flame, wherein the flame is fed with hydrogen and oxygen and water vapor can optionally be supplied thereto.

Hereinbelow, the term “granulate” is to be understood as meaning pyrogenically produced silicon dioxide powders highly compacted by means of the compaction process described in U.S. Pat. No. 5,776,240 or analogously to that process.

Hereinbelow, the term “dispersion” is to be understood as meaning the homogeneous, i.e. uniform, distribution of uncompacted or compacted, i.e. “granulated”, pyrogenic silicon dioxide in a liquid such as water, ethanol or an organic solvent.

The expressions “sintered material” and “sintered glasses” are to be understood as meaning materials and glasses produced from very finely divided powders by means of a process of powder technology and a subsequent sintering step.

The expression “sintering process” is to be understood as meaning processes in which very finely divided powders change after the application of warmth or heat into solid formed bodies or layers which have pores only in part or even no pores at all.

The expression “gel bodies” is to be understood as meaning formed bodies which occur after gelling, that is to say after solidification in the wet or moist state, and which have a skeleton of interconnected particles which is filled with liquid.

The expression “green bodies” is to be understood as meaning dried gel bodies in which the liquid has been removed from the particle skeleton and which have a high degree of porosity.

Advantages of the sintered materials, especially sintered glasses, of the invention are the improved optical transparency of glasses, improved optical homogeneity, improved chemical or mechanical resistance of layers on substrate materials, and the improved ability of formed bodies or fibers to withstand chemical or mechanical loads as compared with materials or glasses produced by means of existing sol-gel processes or colloidal sol-gel processes or by means of a conventional melting process.

The invention has the following advantages:

A higher degree of filling of the dispersions can be produced with the highly compacted powders. The higher degree of filling of the dispersion gives rise to better product properties in the materials produced therefrom, such as, for example, better transparency, as a result of a lower number of seed inclusions and fewer cracks. At the same time, the use of highly compacted powders also gives rise to advantages in terms of process technology: for example, dispersions are easier to prepare with the aid of the highly compacted powder. The advantages in terms of process technology achieved with the use of more highly filled dispersions are, moreover, in the case of sintered materials, that green body shrinkage or sintering shrinkage is reduced. The use of such powders brings other advantages in terms of process technology. For example, by influencing the extent to which the powders used are finely divided or the porosity of the green body, it is possible to lower the sintering temperature in a manner which is not possible using other powders or other production processes without a loss in the quality of the subsequent sintered materials.

In addition, the use, according to the invention, of highly compacted powders leads to better processability within the powder-technological production process owing to an improved capillary and pore structure of the gel body. By using such highly compacted powders, therefore, drying of the gel body can be simplified and the quality of the subsequent product can be improved.

The described sintered materials, especially sintered glasses or glasses, can be used commercially in the production of formed glass bodies, such as, for example, optical fiber preformed bodies (so-called “overcladding tubes” or “core rods”), optical lenses, diffraction gratings, glass crucibles (so-called. “crucibles”), electrical insulators, thermal insulators, magnetic insulators, prisms, containers or apparatus for the chemical or pharmaceutical industries, ingots, formed bodies for the electronics industry, glass bars as a raw material for subsequent further processing, formed bodies having precise requirements as regards accuracy of shape after processing.

In addition, such sintered materials can be used commercially in the coating of other materials, such as metal, plastics or glass, with layers of sintered glass or glass. Sintered materials according to the invention, such as sintered glasses or glasses, can also be used in the production of fibrous materials or fibers.

The described granulates can be used in the production of glasses, especially sintered glasses, ceramics or composite materials, in which the granulates act as a reinforcing filler, and serve as reinforcing fillers in metals, glasses, polymers, elastomers, lacquers or liquids.

The dispersions according to the invention can be used in the production of glasses, especially sintered glasses and in the polishing of semiconductor materials or electric circuits.

### EXAMPLE 1 (ACCORDING TO THE INVENTION)

A pyrogenically produced silicon dioxide having a BET surface area of 90 m²/g and a bulk density of 35 g/l and a tamped density of 59 g/l is compacted to a granulate according to U.S. Pat. No. 5,776,240.

The compacted silicon dioxide has a BET surface area of 90 m²/g and a tamped density of 246 g/l.

180 ml of distilled water is placed in a vessel and, before the introduction of the powder begins, the pH is adjusted to a pH value of 11 using a 30 wt. % KOH solution. 120 g of the compacted granulate is then gradually introduced into the water by means of a dissolver device having a dissolver disk; the speed of rotation of the dissolver is approximately 1000 rpm. When the granulate is completely incorporated into the dispersion, the dispersion is pre-dispersed by means of the dissolver for approximately 30 minutes.

After that time, the pre-dispersed dispersion is dispersed for approximately 120 minutes by means of an Ultra-Turrax rotor-stator dispersing unit at 10,000 rpm and, during the dispersing, is cooled. The dispersing step yields a dispersion which, after standing for 24 hours, has a viscosity in the range of from 200 to 250 mPas/s at 50 rpm (measured using a Brookfield viscometer with spindle 2). The solids content is 40 wt. % in relation to the dispersion.

### EXAMPLE 2 (COMPARATIVE EXAMPLE)

A pyrogenically produced silicon dioxide with a BET surface area of 90 m²/g and a tamped density of 59 g/l is used uncompacted. In addition, 180 ml of distilled water is placed in a vessel and, before the introduction of the powder begins, the pH is adjusted to a pH value of 11 using a 30 wt. % KOH solution. The uncompacted powder is then gradually introduced into the water by means of a dissolver device having a dissolver disk; the speed of rotation of the dissolver is approximately 1000 rpm. However, only 96 g of the uncompacted silicon dioxide can be stirred into a dispersion without the dispersion becoming too viscous. This corresponds to a proportion by mass of 35 wt. % within the dispersion. Compared with 120 g in Example 1 according to the invention, this is a significantly smaller amount. When the powder has been completely incorporated into the suspension, the dispersion is dispersed by means of the dissolver for approximately 30 minutes.

After that time, the dispersed dispersion is dispersed for approximately 120 minutes by means of an Ultra-Turrax rotor-stator dispersing unit at 10,000 rpm and, during the dispersing, is cooled. The dispersing step yields a dispersion which, after standing for 24 hours, has a viscosity in the range of from 330 to 460 mPas/s at 50 rpm (measured using a Brookfield viscometer with spindle 2). As compared with Example 1, where the solids content of the dispersion is 40 wt. % of granulate, only approximately 35 wt. % of the uncompacted powder can be converted into a dispersion. Moreover, the viscosity of the dispersion is markedly higher than in Example 1, which renders the colloidal sol-gel process more difficult.

### EXAMPLE 3 (ACCORDING TO THE INVENTION)

A pyrogenically produced silicon dioxide having a BET surface area of 50 m²/g and a tamped density of 130 g/l is compacted to a granulate according to U.S. Pat. No. 5,776,240.

The compacted silicon dioxide has a BET surface area of 50 m²/g and a tamped density of 365 g/l.

180 ml of distilled water is placed in a vessel and, before the introduction of the powder begins, the pH is adjusted to a pH value of 11 using a 30 wt. % KOH solution. 220 g of the granulate is then gradually introduced into the water by means of a dissolver device having a dissolver disk; the speed of rotation of the dissolver is approximately 1000 rpm. When the granulate is completely incorporated into the dispersion, the dispersion is dispersed by means of the dissolver for approximately 30 minutes.

After that, the dispersion is dispersed for approximately 120 minutes by means of an Ultra-Turrax rotor-stator dispersing unit at 10,000 rpm and, during the dispersing, is cooled. The resulting dispersion has a solids content of approximately 55 wt. %.

### EXAMPLE 4 (COMPARATIVE EXAMPLE)

A pyrogenically produced silicon dioxide has a BET surface area of 50 m²/g and a tamped density of 130 g/l. That powder, which is not highly compacted, is used for comparison with Example 3.

In addition, 180 ml of distilled water is placed in a vessel and, before the introduction of the powder begins, the pH is adjusted to a pH value of 11 using a 30 wt. % KOH solution. The uncompacted powder is then gradually introduced into the water by means of a dissolver device having a dissolver disk; the speed of rotation of the dissolver is approximately 1000 rpm. However, only 180 g of the uncompacted powder can be stirred into the dispersion without the dispersion becoming too viscous. This corresponds to a proportion by mass of 50 wt. % in the dispersion. Compared with 220 g in Example 3, this is a significantly smaller amount. When the powder is completely incorporated into the dispersion, the suspension is dispersed by means of the dissolver for approximately 30 minutes.

After that, the pre-dispersed suspension is dispersed for approximately 120 minutes by means of an Ultra-Turrax rotor-stator dispersing unit at 10,000 rpm and, during the dispersing, is cooled. As compared with Example 3, in which a dispersion with a solids content of 55 wt. % is produced, only a dispersion with a solids content of approximately 50 wt. % can be produced with the uncompacted powder.

### EXAMPLE 5 (ACCORDING TO THE INVENTION)

A pyrogenically produced silicon dioxide having a BET surface area of 90 m²/g and a bulk density of 35 g/l and a tamped density of 59 g/l is compacted according to U.S. Pat. No. 5,776,240.

The compacted silicon dioxide has a BET surface area of 90 m²/g and a tamped density of 246 g/l.

17.2 g of the powder are stirred with 27 ml of distilled water and 2.57 ml of tetramethylammonium hydroxide to form a homogeneous dispersion as described in Examples 1 to 4.

When dispersion is complete, 1 ml of ethyl acetate is added and the dispersion is immediately poured into a form.

After 12 minutes, the dispersion has gelled and the resulting gel body is removed from the form after one hour and dried at room temperature for 6 days.

Drying yields a microporous green body.

The green body is sintered in vacuo for four hours at 1400° C. by means of zone sintering. A sintered glass body without visible seeds or pores is obtained.

### EXAMPLE 6 (ACCORDING TO THE INVENTION)

A pyrogenically produced silicon dioxide having a BET surface area of 300 m²/g and a bulk density of 30 g/l and a tamped density of 50 g/l is compacted according to U.S. Pat. No. 5,776,240.

The compacted silicon dioxide has a BET surface area of 300 m²/g and a tamped density of 289 g/l.

11.2 g of the powder are processed with 27 ml of distilled water and 2.57 ml of tetramethylammonium hydroxide to form a homogeneous dispersion as described in Examples 1 to 4. When dispersion is complete, 1 ml of ethyl acetate is added and the dispersion is immediately poured into a form. After 20 minutes, the dispersion has gelled. The resulting gel body is removed from the form after one hour and dried at room temperature for 7 days. Drying yields a microporous green body.

The green body is sintered in vacuo for four hours at 1400° C. by means of zone sintering. A sintered glass body without visible seeds or pores is obtained.

### EXAMPLE 7 (ACCORDING TO THE INVENTION)

A pyrogenically produced silicon dioxide having a BET surface area of 200 m²/g and a bulk density of 35 g/l and a tamped density of 50 g/l is compacted according to U.S. Pat. No. 5,776,240.

The compacted silicon dioxide has a BET surface area of 200 m²/g and a tamped density of 219 g/l.

18 g of the powder are dried for 24 hours at 105° C. in a drying chamber. The powder is then dry pressed, uniaxially, to a formed body having a diameter of 10 mm.

Pressing is carried out in a steel form at a pressing pressure of 51.2 MPa and with a pressing time of 90 seconds.

The formed body is sintered in vacuo at 1500° C. for 5 hours in a zone-sintering furnace. A sintered glass body without visible seeds or pores is obtained.

1-8. (canceled)

9. A dispersion of granulates of a sintered material produced by means of a forming or compacting process, optionally a subsequent cleaning step and optionally a subsequent sintering process, comprising, as a pre-sintering composition:
a) pyrogenically produced silicon dioxide which has been compacted to granulates having a tamped density of from 150 g/l to 800 g/l, a granulate particle size of from 10 to 800 μm and a BET surface area of from 10 to 500 m₂/g, or
b) pyrogenically produced silicon dioxide which has been compacted to granulates, having the following physico-chemical data:
mean particle diameter: from 25 to 120 μm,
BET surface area: from 40 to 400 m₂/g,
pore volume: from 0.5 to 2.5 ml/g,
pore distribution: no pores with a diameter<5 nm, only meso- and macro-pores are present.
pH value: from 3.6 to 8.5,
tamped density: from 220 to 700 g/I
wherein the solids contents of the granulates from 10 wt. % to 85 wt. %, in a dispersion with a polar or non-polar inorganic or organic liquid.

10. A dispersion of granulates according to claim 9,
which is an aqueous dispersion having a pH value of from 1 to 6 or a pH value of from 8 to 12, and is adjusted to the corresponding pH value using at least one member selected from the group consisting of organic acids, inorganic acids, organic bases, and inorganic bases.

11. A dispersion of granulates 9,
which is an aqueous dispersion having an aqueous dispersion which has a pH value of from 1 to 6 or a pH value of from 8 to 12 and is adjusted to the corresponding pH value using at least one member selected from the group consisting of organic acids, inorganic acids, organic bases and inorganic bases and which contains other additives enabling increased granulate contents and improved dispersibility, which contribute towards steric or ionic stabilization of the dispersion and reduce or prevent settling of solids portions or prevent premature gelling.

12. A dispersion of granulates 9,
which is an aqueous dispersion having an aqueous dispersion which has a pH value of from 1 to 6 or a pH value of from 8 to 12 and is adjusted to the corresponding pH value using organic acids or inorganic acids or organic bases or inorganic bases and which contains additives permitting improved dispersing, gelling, drying, cleaning and sintering of subsequent sintered material.

13. A dispersion of granulates according to claim 9,
which has a solids contents of granulates of from 1 wt. % to 75 wt. %, in an aqueous dispersion which has a pH value of from 1 to 6 or a pH value of from 8 to 12 and is adjusted to the corresponding pH value using organic acids or inorganic acids or organic bases or inorganic bases, wherein pyrogenically produced oxides are added to the dispersion in an amount by weight of from 1 to 65 wt. %, and corresponding pyrogenic oxides are added to the dispersion in uncompacted state or after preliminary compaction.

14. A dispersion of granulates according to claim 9,
which has a solids contents of granulates from 1 wt. % to 75 wt. %, in an aqueous dispersion which has a pH value of from 1 to 6 or a pH value of from 8 to 12 and is adjusted to the corresponding pH value using organic acids or inorganic acids or organic bases or inorganic bases and
which contains additives permitting improved dispersing, gelling, drying, cleaning and sintering of subsequent sintered material, wherein salts or oxides of a metalloid and/or metal may be added to the dispersion.

15-22. (canceled)
